(19) United States
(12) Patent Application Publication
(10) Pub. No.: US 2008/0052357 A1
(43) Pub. Date: Feb. 28, 2008

(54) METHOD, APPARATUS AND COMPUTER PROGRAM PRODUCT FOR IMPLEMENTING DYNAMIC CUSTOMIZATION OF ENVIRONMENT FOR ENHANCED NETWORK MEETING EXPERIENCE

(76) Inventors: Michael John Branson, Rochester, MN (US); Gregory Richard Hintermeister, Rochester, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/466,969

(22) Filed: Aug. 24, 2006

(51) Int. Cl. G06F 15/16

(52) U.S. Cl. 709/205; 709/227; 709/228

(57) ABSTRACT

A method, apparatus and computer program product implement dynamic customization of environment for enhanced network meeting experience. Users connect to a network meeting and environment data are submitted for the users to a computer system for a presenter. A primary recipient is selected by the presenter. A view is rendered of display for at least one recipient for viewing by the presenter. An optimization setting option is selected by the presenter and predefined presentation settings are altered for the network meeting. A selected secondary recipient is selectively suspended by the presenter, for example, based upon a slow connection speed for a selected recipient, or when a maximum number of secondary recipients is reached.

### FIELD OF THE INVENTION

The present invention relates generally to the data processing field, and more particularly, relates to a method, apparatus and computer program product for implementing dynamic customization of environment for enhanced network meeting experience.

### DESCRIPTION OF THE RELATED ART

When running an interactive presentation over the Internet, for example, a Sametime® Meeting or other net-conferencing product, there can be many users watching, and each user can have a different experience.

Some of those differences include, for example, resolution differences between different users. Differences in resolution allows some users to see the whole presentation, some users to see only parts, while others users want to see more but cannot because the originator has chosen an incompatible resolution. This is especially critical during a demo, where key parts of the user interface for the demo may be missed by a viewer due to resolution differences while the presenter is oblivious to any viewer's poor experience.

Other differences include, for example, presets so that “full screen” and “Fit to screen” are turned on for some and off for others. A set refresh rate can allow some users to see the presentation refresh quickly and follow along, while others wait for the image for quite some time. A maximum number of recipients can be reached so other users are not allowed to view the presentation.

The side effects of these problems are an ineffective presentation, which becomes a critical problem, for example, when an important recipient, such as, an executive, customer, other decision-maker, becomes frustrated with the experience and hangs up or gets a bad impression of the presenter and presentation.

A presenter needs to be aware of such problems, and advantageously has the ability to see what the recipients are experiencing, and has the ability to optimize either the recipients settings or optimize the presenting PC's settings so the presentation is better for all recipients. There also needs to be a way to control how many recipients are active in order to optimize the experience for important recipients.

A need exists for an effective mechanism for implementing dynamic customization of environment for enhanced network meeting experience.

### SUMMARY OF THE INVENTION

Principal aspects of the present invention are to provide a method, apparatus and computer program product for implementing dynamic customization of environment for enhanced network meeting experience. Other important aspects of the present invention are to provide such method, apparatus and computer program product for implementing dynamic customization of environment for enhanced network meeting experience substantially without negative effect and that overcome many of the disadvantages of prior art arrangements.

In brief, a method, apparatus and computer program product implement dynamic customization of environment for enhanced network meeting experience. Users connect to a network meeting and environment data are submitted for the users to a computer system for a presenter. A primary recipient is selected by the presenter. A view is rendered of a display for at least one recipient for viewing by the presenter. An optimization setting option is selected by the presenter; and predefined presentation settings are altered for the network meeting responsive to the selected optimization setting option.

In accordance with features of the invention, a selected secondary recipient is selectively suspended by the presenter, for example, when the view indicates that the recipient is the cause of a general slow-down, for example, based upon slow connection speed, or when a maximum number of secondary recipients has been reached.

In accordance with features of the invention, based upon a predetermined priority of the recipients and refresh rate threshold; selected secondary recipients advantageously are automatically suspended until the primary recipient's refresh rate is achieved.

In accordance with features of the invention, the view rendered of the display for at least one recipient for viewing by the presenter is adapted to give the presenter an indication of a respective viewer's experience. Views of what the primary and secondary users see optionally are shown to the presenter and are updated throughout the meeting as settings may change. Views of connection performance of each viewer's current performance optionally are shown and are periodically updated throughout the meeting as settings may change.

In accordance with features of the invention, the altered predefined presentation settings for the network meeting include source settings for the presenter that are optimized based upon the presentation settings of the primary recipient. The altered predefined presentation settings for the network meeting include presentation settings for the primary recipient, and can include presentation settings for one or more secondary recipients. The settings be altered includes a selected one of resolution, meeting preferences the viewers have selected, such as, full-screen, and fit to window, refresh rate and the data rate of the viewer's connection.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A and 1B are block diagram representations illustrating an exemplary computer system and operating system for implementing methods for dynamic customization of environment for enhanced network meeting experience in accordance with the preferred embodiment;

FIG. 2 is a flow chart illustrating exemplary steps for implementing dynamic customization of environment for enhanced network meeting experience in accordance with the preferred embodiment; and

FIG. 3 is a block diagram illustrating a computer program product in accordance with the preferred embodiment.

### DETAILED DESCRIPTION OF THE PREFERRED EMBODIMENTS

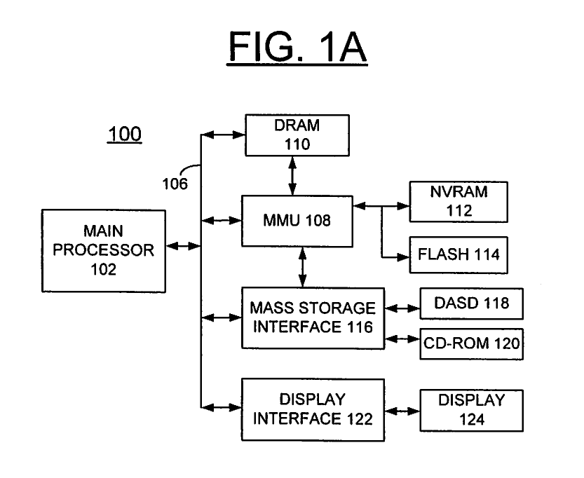

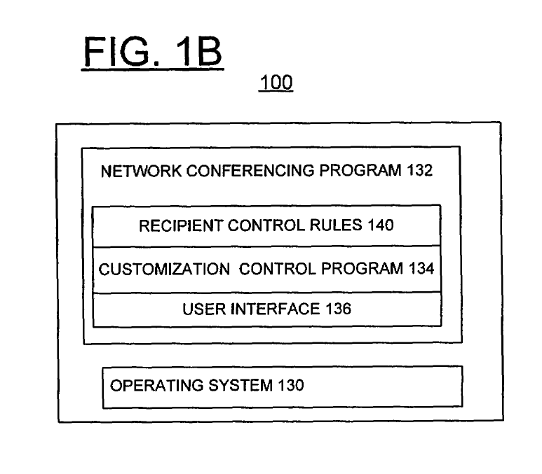

Having reference now to the drawings, in FIGS. 1A and 1B, there is shown an exemplary server or computer system generally designated by the reference character 100 for implementing methods for dynamic customization of environment for enhanced network meeting experience in accordance with the preferred embodiment. Computer system 100 includes a main processor 102 or central processor unit (CPU) 102 coupled by a system bus 106 to a memory management unit (MMU) 108 and system memory including a dynamic random access memory (DRAM) 110, a nonvolatile random access memory (NVRAM) 112, and a flash memory 114. A mass storage interface 116 coupled to the system bus 106 and MMU 108 connects a direct access storage device (DASD) 118 and a CD-ROM drive 120 to the main processor 102. Computer system 100 includes a display interface 122 coupled to the system bus 106 and connected to a display 124.

Computer system 100 is shown in simplified form sufficient for understanding the present invention. The illustrated computer system 100 is not intended to imply architectural or functional limitations. The present invention can be used with various hardware implementations and systems and various other internal hardware devices, for example, multiple main processors.

As shown in FIG. 1B, computer system 100 includes an operating system 130, a network conferencing program 132, a customization control program 134 of the preferred embodiment, and a user interface 136. Recipient control rules 140 are identified and stored in accordance with presenter selections for selectively implementing dynamic customization control methods of the preferred embodiment.

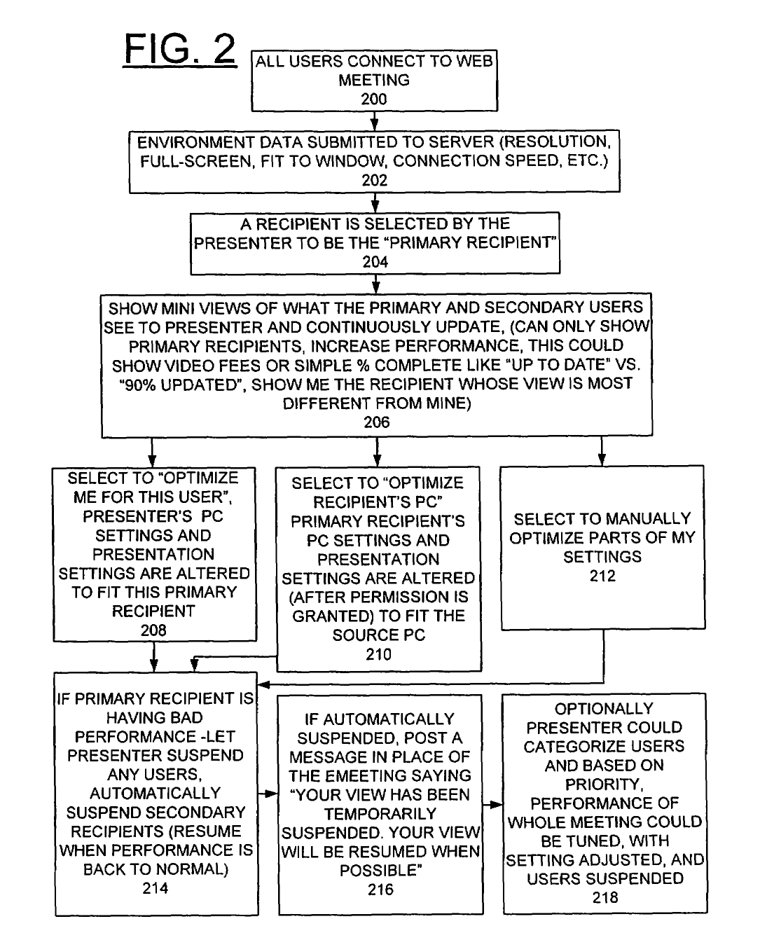

Various commercially available computers can be used for computer system 100, for example, an IBM server computer, such as an IBM eServer iSeries® system. CPU 102 is suitably programmed by the network conferencing program 132 and the customization control program 134 to execute the flowchart of FIG. 2 for implementing methods for dynamic customization of environment for enhanced network meeting experience in accordance with the preferred embodiment.

In accordance with features of the preferred embodiments, a method provides dynamic methods to monitor and customize the environment of presenters and recipients. A presenter is enabled to present using source material while watching a small window to see what the recipients are seeing. One or more small windows can be opened for multiple users. This method also provides a way to select one of the users to optimize for. If presenting to a primary recipient, all other recipients are secondary. This invention enables a primary recipient's settings be altered, including for example, resolution, full-screen, fit to window, and other settings. This invention also enables a presenter to automatically optimize the source computer's settings based upon the primary recipient's settings by clicking an “Optimize Me For This User” button on the small window of the primary recipient. A presenter is enabled to selectively suspend certain recipients, for example, when the small window would indicate that this recipient is the cause of a general slow-down, for example, based upon slow connection speed, and the like, or if a primary recipient cannot sign on, for example, because a maximum number has been reached.

In accordance with features of the preferred embodiments, the method can be extended so that based upon a predetermined priority of the recipients and refresh rate threshold; secondary recipients may automatically be suspended until the primary recipient's refresh rate is achieved. If this happens, a message is displayed or rendered for viewing by the selected secondary recipients saying that their view has been temporarily suspended, thus removing otherwise resulting audio clutter of, such as, “I can't see the demo anymore”.

Referring now to FIG. 2, there are shown exemplary steps for implementing methods for dynamic customization of environment for enhanced network meeting experience in accordance with the preferred embodiment. As indicated in a block 200, all users connect to a network meeting. The presenter connects to the web server, which handles the network meeting. As each member of the network meeting joins, data is exchanged with the meeting software or customization control program 134 to indicate the resolution of each of the viewers, the meeting preferences the viewers have selected, the data rate of the viewer's connection, and the like as indicated in a block 202. A recipient is selected by the presenter to be the primary recipient or primary listener as indicated in a block 204.

A mini-window is rendered for viewing by the presenter in the network meeting to give the presenter an indication of respective viewer's experience as indicated in a block 206. Views of what the primary and secondary users see are shown to the presenter at block 206 and are continuously updated. Throughout the meeting as settings may change, the mini-window view or views are also changed accordingly at block 206. Connection performance is periodically monitored or tested by the network meeting customization control program 134 to keep an accurate account of the viewers' current performance.

At block 206 as the recipients connect or chime in, the presenter can see a small window showing what the recipients see, or a progress indicator showing data rate and % complete of data sent. These windows can have a “stay on top” toggle. A simple menu action can hide/show these windows.

In accordance with features of the preferred embodiments, as the presentation is about to start, the presenter can view the data rate, percent complete of refreshing respective recipient's display, and optionally show the content that the respective recipient sees. This is done by the computer system 100 knowing the content of the data, data transfer rate to each recipient, as well as what data has already been sent to the recipient. It is not required for the recipient's PC to actually send current data to the computer system 100 or the presenter, the work to show the recipient's data rate is done entirely by the server and the presenter.

A presenter can select an “optimize me for this user” button as indicated in a block 208, the presenter's PC settings and presentation settings are altered to fit this primary recipient selected at block 204.

A presenter can select an “optimize recipient's PC” button for the primary recipient selected at block 204 and based on permission being granted, PC settings and presentation setting can be altered on the recipient's PC as indicated in a block 210.

Also a presenter can select to manually optimize parts of my settings as indicated in a block 212, and selected ones of the presenter's PC settings and presentation settings are altered.

Based on refresh performance reported by the computer system 100, selected individual recipients' participation may be suspended by clicking a “Suspend” button, selected individual recipients can be automatically suspended, for example, based upon a maximum number having been reached and then resumed when performance is back to normal as indicated in a block 214. If selected individual recipients are automatically suspended, a message is posted in place of the normal E-meeting saying, for example, “your view has been temporarily suspended, your view will be resumed when possible” as indicated in a block 216.

As indicated in a block 218, optionally a presenter could categorize users based on priorities, performance of whole meeting could be tuned with settings adjusted, such as refresh rate thresholds, for respective secondary recipients and selected secondary recipients may be suspended.

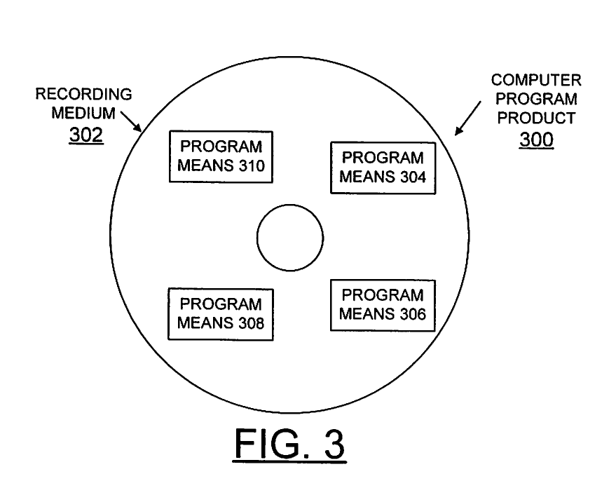

Referring now to FIG. 3, an article of manufacture or a computer program product 300 of the invention is illustrated. The computer program product 300 includes a recording medium 302, such as, a floppy disk, a high capacity read only memory in the form of an optically read compact disk or CD-ROM, a tape, a transmission type media such as a digital or analog communications link, or a similar computer program product. Recording medium 302 stores program means 304, 306, 308, 310 on the medium 302 for carrying out the methods for dynamic customization of environment for enhanced network meeting experience of the preferred embodiment in the computer system 100 of FIGS. 1A and 1B.

A sequence of program instructions or a logical assembly of one or more interrelated modules defined by the recorded program means 304, 306, 308, 310, direct the computer system 100 for implementing dynamic customization of environment for enhanced network meeting experience of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. A method for implementing dynamic customization of environment for enhanced network meeting experience comprising:
connecting users to a network meeting and submitting environment data for the users to a computer system for a presenter;
selecting a primary recipient by the presenter;
rendering a view of a display for at least one recipient for viewing by the presenter;
selecting an optimization setting option by the presenter; and
responsive to said selected optimization setting option, altering predefined presentation settings for the network meeting.

2. A method for implementing dynamic customization of environment as recited in claim 1 wherein rendering the view rendered of the display for at least one recipient for viewing by the presenter includes rendering a view representing what at least one recipient sees.

3. A method for implementing dynamic customization of environment as recited in claim 1 wherein rendering the view of the display for at least one recipient for viewing by the presenter includes rendering a view of connection performance for at least one recipient to give the presenter an indication of at least one recipient's experience.

4. A method for implementing dynamic customization of environment as recited in claim 1 wherein rendering the view of the display for at least one recipient for viewing by the presenter includes periodically updating the view throughout the meeting.

5. A method for implementing dynamic customization of environment as recited in claim 1 wherein altering predefined presentation settings for the network meeting includes altering predefined source settings for the presenter based upon predefined presentation settings of the primary recipient.

6. A method for implementing dynamic customization of environment as recited in claim 1 wherein altering predefined presentation settings for the network meeting includes altering presentation settings for the primary recipient.

7. A method for implementing dynamic customization of environment as recited in claim 1 wherein altering predefined presentation settings for the network meeting includes altering predefined presentation settings including a selected one of resolution, full-screen, fit to window, refresh rate and the data rate.

8. A method for implementing dynamic customization of environment as recited in claim 1 wherein selecting an optimization setting option by the presenter includes selecting an optimization setting option to optimize predefined presentation settings for the presenter.

9. A method for implementing dynamic customization of environment as recited in claim 1 wherein selecting an optimization setting option by the presenter includes selecting an optimization setting option to optimize predefined presentation settings for the primary recipient.

10. A method for implementing dynamic customization of environment as recited in claim 1 includes selectively suspending a selected secondary recipient having a slow connection speed responsive to a predefined entry by the presenter.

11. A method for implementing dynamic customization of environment as recited in claim 1 includes selectively suspending a selected secondary recipient responsive to a maximum number of secondary recipients having been reached.

12. A method for implementing dynamic customization of environment as recited in claim 1 includes selectively suspending a selected secondary recipient based upon a predetermined priority of the users and a predefined refresh rate threshold.

13. A method for implementing dynamic customization of environment as recited in claim 1 includes automatically selectively suspending a selected secondary recipient, and resuming said selected secondary recipient when a refresh rate the primary recipient is achieved.

14. A computer program product for implementing dynamic customization of environment for enhanced network meeting experience, said computer program product including instructions stored on a computer readable storage medium, said instructions when executed by a computer system to cause the computer system to perform the steps of:
connecting users to a network meeting and submitting environment data for the users to a computer system for a presenter;
selecting a primary recipient by the presenter;
rendering a view of a display for at least one recipient for viewing by the presenter;
selecting an optimization setting option by the presenter;
responsive to said selected optimization setting option, altering predefined presentation settings for the network meeting; and
selectively suspending at least one selected secondary recipient based upon a predetermined priority of the users and a predefined refresh rate threshold.

15. A computer program product as recited in claim 14 further includes selectively suspending a selected secondary recipient having a slow connection speed responsive to a predefined entry by the presenter.

16. A computer program product as recited in claim 14 further includes selectively suspending a selected secondary recipient responsive to a maximum number of secondary recipients having been reached.

17. A computer program product as recited in claim 14 wherein altering predefined presentation settings for the network meeting includes altering predefined source settings for the primary recipient.

18. A computer program product as recited in claim 14 wherein altering predefined presentation settings for the network meeting includes altering predefined source settings for the presenter based upon predefined presentation settings of the primary recipient.

19. A computer program product as recited in claim 14 wherein altering predefined presentation settings for the network meeting includes altering presentation settings for the primary recipient, said presentation settings including a selected one of resolution, full-screen, fit to window, refresh rate and the data rate.

20. Apparatus for implementing dynamic customization of environment for enhanced network meeting experience comprising:
a customization control program connecting users to a network meeting and submitting environment data for the users to a computer system for a presenter;
said customization control program selecting a primary recipient by the presenter, responsive to a predefined entry by the presenter;
said customization control program rendering a view of a display for at least one recipient for viewing by the presenter;
said customization control program, responsive to a selected optimization setting option entered by the presenter, altering predefined presentation settings for the network meeting; and
said customization control program selectively suspending at least one selected secondary recipient based upon a predetermined priority of the users and a predefined refresh rate threshold.

21. A method for deploying computing infrastructure, comprising integrating computer readable code into a computing system, wherein the code in combination with the computing system is capable of performing the method of claim 1.
